(19) United States
(12) Patent Application Publication
(10) Pub. No.: US 2016/0042135 A1
(43) Pub. Date: Feb. 11, 2016

(54) DECISION SUPPORT SYSTEM AND METHOD OF POSITIVE OUTCOME DRIVEN CLINICAL WORKFLOW OPTIMIZATION

(71) Applicants: Dan Hogan, Nashville, TN (US); Gerry Andrady, Nashville, TN (US); Edward Woo, Nashville, TN (US); Bryan Mosher, Nashville, TN (US)

(72) Inventors: Dan Hogan, Nashville, TN (US); Gerry Andrady, Nashville, TN (US); Edward Woo, Nashville, TN (US); Bryan Mosher, Nashville, TN (US)

(21) Appl. No.: 14/821,321

(22) Filed: Aug. 7, 2015

Related U.S. Application Data
(60) Provisional application No. 62/034,368, filed on Aug. 7, 2014.

(51) Int. Cl. G06F 19/00

(52) U.S. Cl. CPC G06F 19/345

(57) ABSTRACT

A decision support system provides workflow optimization for healthcare providers. A data repository includes patient profile data and receives real-time patient condition data from a sensor network and workflow data for the provider. The system determines a relative risk value for patients with respect to a negative outcome such as hospital transfer, and defines at-risk patients with respect to the determined negative outcome. Positive outcomes having an inverse correlation with respect to the negative outcome are determined, such as hospice admission without transfer. A clinical workflow is defined as a sequence of treatment stages associated with the determined positive outcome, and provider activity tracked for the at-risk patients with respect to first threshold values, the system further tracking a degree of provider compliance with the clinical workflow stages based on second threshold values. The system may dynamically modify threshold values for workflow stages based on client conditions, provider resources, etc.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of U.S. Provisional Patent Application No. 62/034,368, dated Aug. 7, 2014, and which is hereby incorporated by reference.

### BACKGROUND OF THE INVENTION

The present invention relates generally to healthcare systems and methods. More particularly, this invention relates to a decision support system for healthcare providers based on predictive analytics. Still more particularly, this invention relates to providing decision support feedback in positive outcome-driven clinical workflow optimization.

### BRIEF SUMMARY OF THE INVENTION

Systems and methods as disclosed herein are believed to have beneficial reach well beyond the primary embodiments disclosed herein, namely with respect to home health entities and hospice transfer solutions, and one of skill in the art may appreciate the applicability of core features of these systems and methods in areas as diverse as insurance, commercial distribution, penal systems, and the like.

Patients discharged from acute-care facilities are often prescribed to home health services. Within this patient group exists a spectrum of illness severities in addition to patients at risk of expiring while on the home health census or at home shortly after discharge. For these patients, home health services may not be the optimal venue of care. Hospice care is a pivotal piece in the coordinated care service plan that provides a constant source of information on patient status as well as emotional support to the patient's family. Supporting literature on hospice care contains surveys of families with soon-to-be expiring family members who voiced that an earlier referral to hospice would have been preferred and would have provided the right level of care and a better end of life experience.

Regarding healthcare generally, hospital readmission reduction is a major priority in the overall decrease in national healthcare spending. Nearly one in five patients are readmitted following an initial discharge from the hospital, with 17.6% of all hospital admissions resulting in readmissions within 30 days of discharge, 11.3% within 15 days, and 6.2% within 7 days. Readmissions have cost Medicare more than $17 billion, and over 60% of all hospital costs are attributable to repeat admissions for the same disease. Hospitals are now faced with substantial financial penalties for high readmission rates, but despite these penalties, readmission rates have only dropped 0.1% since 2007.

Roughly 80% of hospital readmissions are for patients 65 years of age and older. By 2030, it is expected that this population segment will grow to over one billion worldwide, threatening hospitals with increased readmission costs. The 65-and-over age group is susceptible to health issues, particularly as patients reach their end-of-life stage. Healthcare providers and families are faced with a difficult decision as to when to discharge a patient into hospice care to cease treatment of the adverse symptom and transfer the patient into a quality of life phase. By discharging a patient too early, a hospital increases the risk of readmission and associated expenses; by discharging a patient too late, a hospital risks decreasing the quality of life for a patient by subjecting the patient to invasive, uncomfortable medical procedures that will have minimal or no effect on prolonging life.

Current hospital treatment methods for solving hospital readmissions, such as the implementation of Electronic Health Records (EHR) systems, are designed to gather large quantities of data and create a treatment workflow for preventing negative outcomes. These methods are one-dimensional in scope and are focused on the optimal prevention of a negative outcome. In the case of end-of-life decision support, treatment workflows are singularly designed to extend lifespan. These solution systems are extremely robust and contain thousands of tables of data gathered for the determination of workflow efficacy, namely whether the preventative measures are reducing risk of death.

These one-dimensional systems do not effectively address the problem of readmission rates. By focusing only on treating the cause for current admission, these treatment systems are often too narrow in scope to provide effective analytics for decision-making regarding likelihood for readmission or other mitigating factors such as preserving quality of life. As such, a clinical workflow that has a ˜100% likelihood of recovery but results in a ˜100% likelihood of readmission may be deemed effective and desirable.

Furthermore, these traditional clinical workflow systems may make it more difficult for a clinician to make effective decisions regarding when to discharge a patient from a current workflow and into another. Current EHR systems may have patient records with thousands of fields of data to be used in calculating negative outcome prevention. Much of this data is irrelevant to any singular healthcare decision and, therefore, is likely to get in the way of effective decision-making capabilities by overloading the clinician with too much irrelevant information. While helpful for determining an immediate healthcare solution, these one-dimensional systems fail to appropriately address readmission minimization and the impact of mitigating factors such as preserving quality of life.

Therefore, what is needed are healthcare systems and methods that determine clinical workflows based not only upon treatment steps for mitigating one or more negative outcomes but also upon workflow steps for maximizing one or more countervailing positive outcomes, thereby determining a clinical workflow that maximizes positive outcomes such as survivability and quality of life while minimizing negative outcomes such as expiration and patient readmission, By measuring and comparing both positive and negative outcomes, such systems and methods increase expense efficiency while maximizing efficacy of patient care. Specifically, comparative analytics within such systems and methods will assist clinicians in determining which patients will benefit from timely discharge into hospice care, thereby minimizing cost and maximizing quality of life without dramatically increasing the likelihood of costly readmission.

Systems and methods implementing predictive modeling-based hospice transfer solutions as disclosed herein help pool through patient and home care agency data to deliver concrete insights that help clinicians and patients' families understand when care should focus primarily on treating the patient rather than the disease. By analyzing clinical and demographic Oasis-C variables, patient medication histories, comorbid acuities, vital signs and home care agency specific data, a hospice transfer tool as disclosed herein may generate a new report, e.g., every 24 hours, that details the top 5, 10 and 25 percent of patients who would benefit most from palliative care. This equips clinicians with concrete information that can help them, physicians, patients and patients' families determine if it's the right time to transfer out of home health into hospice care.

A hospice transfer notification solution as disclosed herein may be desirable for dual home care/hospice operators, as implementing readmission reduction predictive modeling solutions to identify patients who were at the greatest risk of hospital readmission would have the resultant effect of further recognizing the patients best suited for transfer to hospice.

Therefore, one desirable aspect of the present disclosure is a decision support system which assists a healthcare provider with respect to resource allocation, in that the system identifies a group of patients that are at-risk for a particular negative event or outcome associated with one or more services treated by or otherwise associated with the provider.

It is further desirable that the decision support system not only assists the provider in identifying such patients, but further identifies a positive outcome that has some inverse correlation with respect to the negative outcome, and defines a clinical workflow associated with the positive outcome. As one example, the healthcare provider may provide more benefit for the associated patients by alleviating pain (or other positive outcome) rather than by addressing the negative outcome.

It is even further desirable that the system monitors compliance by the healthcare provider with each of a desired “coverage ratio” of at-risk patients treated, and criteria associated with the clinical workflow. As one example, the provider may be required to progress patients through a predefined sequence of events in a certain period of time, or through each of the events in respectively defined times. As another example, the provider may be required to maintain a certain ratio of patients in the workflow rather than remove them, or alternatively maintain and not remove a certain number of stages in the workflow itself. In this way the system monitors and recommends actions by the healthcare provider with respective to objectives that are not obvious to those presently of skill in the art for addressing the negative outcome itself, while providing demonstrably improved results in the overall well-being of the subject patients.

As mentioned briefly above, such systems and methods may find suitable application in other areas such as, for example, education systems and penal systems. In particular cases where attempts to address a negative outcome (e.g., dropping out of school, truancy) alone have been ineffective or inefficient, the systems and methods may achieve improved results by causing the client entity to, for example, institute and comply with workflow that drives a positive outcome having an inverse correlation with the negative outcome. This positive outcome is not merely the lack of the negative outcome itself (e.g., not dropping out of school), but a separate but related outcome having inverse correlations as may be determined through statistical analysis and/or appropriate predictive analytics.

In a particular embodiment as disclosed herein, a server system provides decision support regarding clinical workflows for a healthcare provider having a census of patients. The server is functionally linked to a data repository comprising profile data for each of the census of patients, and includes a processor and a computer program product executable by the processor to direct the following operations. The system determines each of a negative outcome associated with services of the healthcare provider and a positive outcome having an inverse correlation with respect to said negative outcome. A group of patients is defined from among said census of patients as being at-risk with respect to the determined negative outcome, and the system further defines a clinical workflow as a sequence of one or more treatment stages associated with the determined positive outcome. The system further tracks a degree of activity by the healthcare provider for the defined group of at-risk patients and with respect to a first threshold value, and a degree of compliance by the healthcare provider with the clinical workflow based on a second threshold value. The system further generates a graphical interface on a display unit for a user device comprising feedback data regarding a failure to satisfy either of a first condition associated with the first threshold value and a second condition associated with the second threshold value.

In one aspect of such an embodiment, the aforementioned step of tracking a degree of compliance may involve tracking an amount of time for each patient with respect to the clinical workflow.

In another aspect, wherein the second threshold value is made up of one or more threshold time values respectively corresponding to the one or more stages of the clinical workflow, the step of tracking a degree of compliance may include tracking an amount of time for each patient with respect to each of the one or more stages of the clinical workflow with respect to the corresponding threshold time values.

In another aspect, the one or more threshold time values are dynamically determined for the healthcare provider, further wherein the system may adjust some or all of the one or more threshold time values based on the feedback data.

In another aspect, the one or more threshold time values are dynamically determined for some or all of the census of patients, further wherein the system may adjust some or all of the one or more threshold time values based on the feedback data.

In another aspect, the system further tracks a number of instances of any of the one or more patients being removed from the workflow.

In another aspect, the system further tracks a number of instances of any of the one or more stages being removed from the workflow.

### BRIEF DESCRIPTION OF THE SEVERAL VIEWS OF THE DRAWINGS

FIG. 1 is a block diagram representing an embodiment of a decision support system for clinical workflow optimization in accordance with the present disclosure.

FIG. 2 is a flowchart representing an embodiment of a decision support method for clinical workflow optimization in accordance with the present disclosure.

FIG. 3 is a block diagram representing an embodiment of a machine learning-based clinical workflow feedback loop in accordance with the present disclosure.

FIG. 4 is a flowchart representing an example of an automated risk assessment process conducted in accordance with the present disclosure.

FIG. 5 is a flowchart representing an example process for variable cross checking according to embodiments of the present disclosure.

### DETAILED DESCRIPTION OF THE INVENTION

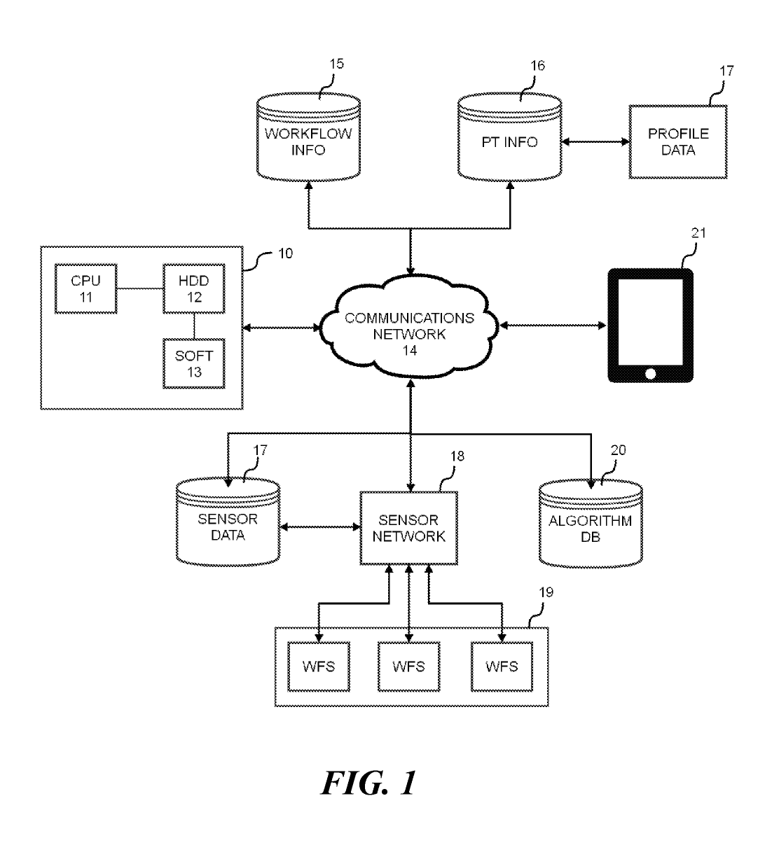

Referring generally to FIGS. 1-5, various exemplary embodiments of an invention may now be described in detail. Where the various figures may describe embodiments sharing various common elements and features with other embodiments, similar elements and features are given the same reference numerals and redundant description thereof may be omitted below.

In a particular embodiment as disclosed herein, a server system provides decision support regarding clinical workflows for a healthcare provider having a census of patients. It may be understood that while the clinical workflow example for healthcare providers is referred to in illustrative fashion throughout the remainder of this description, in various alternative embodiments a system and associated methods of the present disclosure may be applicable in other fields, such as for example but without limitation: an education provider having a census of educators and/or students; an athletic organization or facility having a census of trainers, employees and/or clients; an employer or healthcare plan administrator having a census of employees; a penal administrative entity having a census of employees and/or inmates; and the like.

In various embodiments the system may have a network structure residing on or across one or more host servers and which is effective to receive and transmit data over a communications network with one or more computers on remote servers such as may be associated with various separate data sources and/or one or more computers or communications devices associated with healthcare entities. The healthcare entities may include for example home health agencies and equivalent groups as well as individual practitioners and health care providers. The data sources in one context may include any computer or server upon which resides a database containing patient data which can be effectively extracted and converted by program modules of the host system. In another context, data sources may include entities or parties who provide patient data directly to an interface generated by the host system, such as for example by manual data entry or by uploading of a data file having a format accessible by program modules of the host system.

In various embodiments, the system determines each of a negative outcome associated with services of the healthcare provider and a positive outcome having an inverse correlation with respect to said negative outcome. Often, the negative outcome at issue may be provided by the healthcare provider or otherwise predetermined with respect to services associated with the healthcare provider. However, in some embodiments the system may utilize any one or more of third party evidence, statistical analysis and predictive analytics in order to define or otherwise recommend a negative outcome to be addressed. Likewise, while the positive outcome having an inverse correlation to the negative outcome at issue may be provided by the healthcare provider or otherwise predetermined with respect to services associated with the healthcare provider, in some embodiments the system may utilize any one or more of third party evidence, statistical analysis and predictive analytics in order to define or otherwise recommend a positive outcome to be addressed.

In some embodiments, the system may define a plurality of negative outcomes associated with the healthcare provider, or more particularly with potential respect to an associated census of patients. One or more positive outcomes may subsequently be defined with respect to the plurality of negative outcomes. In another example, a plurality of positive outcomes may be defined by the system with respect to each of one or more negative outcomes. The number of negative and/or positive outcomes may in various embodiments often be limited to one by evidence indicating inefficiency, a lack of effectiveness, a lack of client interest in such workflow complexity, or the like, but systems and methods as disclosed herein are not inherently limited unless otherwise stated.

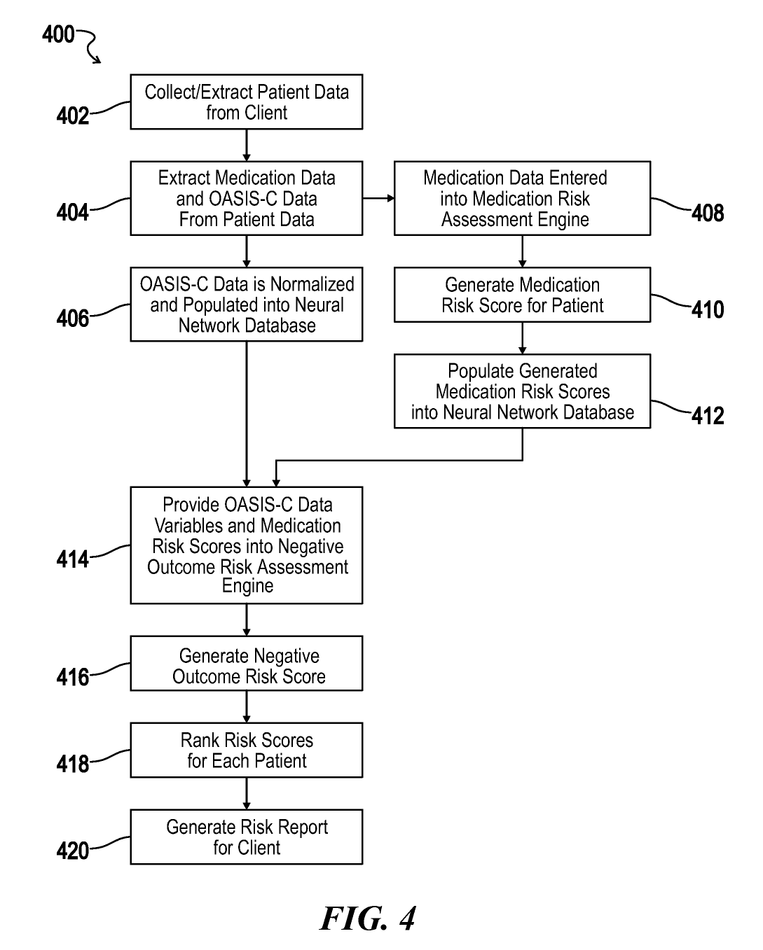

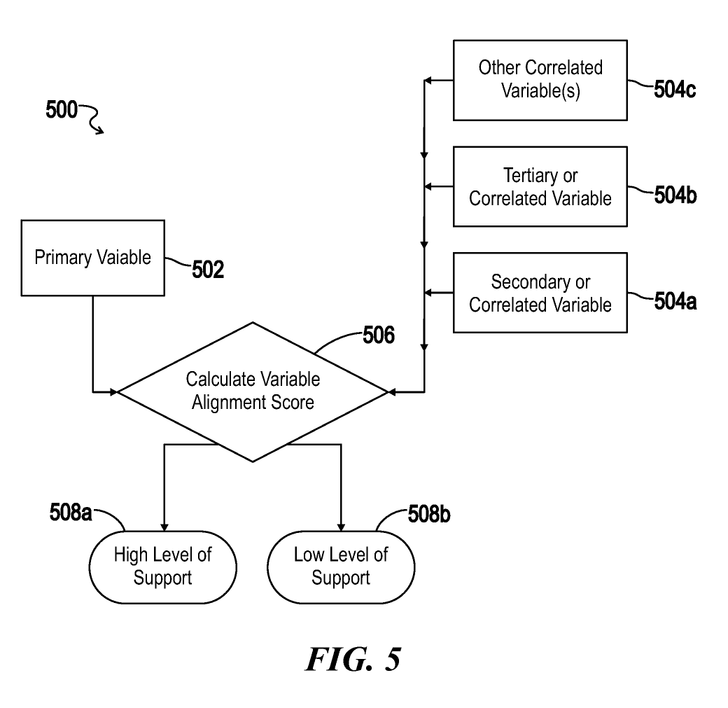

A group of patients is defined from among said census of patients as being at-risk with respect to the determined negative outcome. Examples of algorithms, rules-based or otherwise, as well as predictive analytics engines for implementing this step may include but are not limited to structures and processes as described below and further with respect to FIGS. 4 and 5.

The system further defines a clinical workflow as a sequence of one or more treatment stages associated with the determined positive outcome. Often, the clinical workflow will be provided by the healthcare provider or otherwise predetermined with respect to the particular positive outcome. However, in some embodiments the system may utilize any one or more of third party evidence, statistical analysis and predictive analytics in order to define or otherwise recommend a clinical workflow for the particular positive outcome.

The system further tracks a degree of activity by the healthcare provider for the defined group of at-risk patients and with respect to a first threshold value, and a degree of compliance by the healthcare provider with the clinical workflow based on a second threshold value.

In one example, the second prong of this analysis may involve tracking an amount of time for each patient with respect to the clinical workflow. Alternatively, wherein the second threshold value is made up of one or more threshold time values respectively corresponding to the one or more stages of the clinical workflow, this may include tracking an amount of time for each patient with respect to each of the one or more stages of the clinical workflow with respect to the corresponding threshold time values.

In one embodiment, the one or more threshold time values may be dynamically determined by the system for the healthcare provider, or even in some cases with respect to individual patients, wherein some or all of the one or more threshold time values may be adjusted over time based on feedback data.

In one embodiment, the system may track a number of instances of any of the one or more patients, or alternatively any of the one or more stages themselves, being removed from the workflow.

The system further generates a graphical interface on a display unit for a user device comprising feedback data regarding a failure to satisfy either of a first condition associated with the first threshold value and a second condition associated with the second threshold value. The feedback data may simply take a display form such as for example analytics, reports or the like upon request by the client user. Alternatively, the system may more dynamically generate alerts and recommendations to the client user based on failures to comply with the threshold requirements of the coverage ratio and the clinical workflow.

The feedback loops of a system and method as disclosed herein may accordingly comprise multiple tiers including each of the one or more different steps/stages in the clinical workflow, relational downstream effects for each of the stages, and predictive effects on an associated positive outcome, as well as correlative inverse effects with respect to the defined negative outcome for which the positive outcome has been introduced in the first place.

As mentioned previously, the feedback loops may desirably account for distinctions that are specific to the particular healthcare provider, the particular patient, the negative outcome at issue, and any related aspects as may be determined to be correlative over time. Important distinctions may be accounted for with respect to second-order factorials, where for example there are defined relational effects with respect to a particular provider that should necessarily be weighed by the system but not applied to the exclusion of other and perhaps more principal first-order factorials. The system may therefore consider criteria such as for example baseline values for a particular entity, historical performance, fixed costs, patient feedback, and the like.

As well, an inverse correlation between the positive and negative outcomes may be monitored and scored over time with respect to effectiveness and/or cost savings. A positive outcome which is associated with a complex and costly clinical workflow may not be desirable in some cases where the resultant beneficial effects for the provider and patient are insufficient to justify the time and expense, particularly when viewed with respect to the negative outcome at issue.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Depending on the embodiment, certain acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The term “user interface” as used herein may unless otherwise stated include any input-output module with respect to the hosted server including but not limited to web portals, such as individual web pages or those collectively defining a hosted website, mobile device applications, telephony interfaces such as interactive voice response (IVR), and the like. Such interfaces may in a broader sense include pop-ups or links to third party websites for the purpose of further accessing and/or integrating associated materials, data or program functions via the hosted system and in accordance with methods of the present invention.

The term “communications network” as used herein with respect to data communication between two or more parties or otherwise between communications network interfaces associated with two or more parties may refer to any one of, or a combination of any two or more of, telecommunications networks (whether wired, wireless, cellular or the like), a global network such as the Internet, local networks, network links, Internet Service Providers (ISP's), and intermediate communication interfaces.

FIG. 1 is a block diagram representing an embodiment of a decision support system for clinical workflow optimization in accordance with the present disclosure. A server 10 is comprised of a central processing unit 11 and storage medium or memory medium 12 with one or more program modules 13 stored thereupon. The software instructions 16 may be executable by the central processing unit 11 to perform various steps including identifying one or more groups of at-risk patients, identifying positive and negative outcomes for a group of at-risk patients, defining and recommending clinical workflows in association with the positive and negative outcomes, monitoring clinical workflow performance and adherence through one or more external inputs, and adjusting definitions and recommendations of clinical workflows based upon a clinical workflow feedback loop incorporating said external inputs.

The server 10 may be communicatively connected to a plurality of databases via a communications network 14. In an embodiment, databases may be directly connected to or contained within the server 10. Said databases may include a workflow information database 15 configured to store at least clinical workflows and associated workflow data. Associated workflow data may include clinical workflow attributes including associated negative outcomes and associated positive outcomes, associated threshold values including threshold time values, and associated mitigating factors such as risk and cost.

The server 10 may also be communicatively connected to a patient information database 16. The patient information database 16 may be associated with one or more of: a healthcare provider's electronic health records (EHR) or electronic medical records (EMR) database, a healthcare provider's automatic discharge and transfer (ADT) system, a healthcare provider's hospital information system (HIS), and other such systems and databases where patient-related data may be stored. The patient information database 16 may contain profile data 17 for each patient from which the software instructions 13 can identify one or more patients above a threshold risk of a negative outcome and classify said patients as an at-risk patient group. For example, the software instructions 13 may identify a group of patients at risk for heart failure based upon patient profile data 17 including age, sex, blood pressure, diagnoses, and other such factors. The software instructions 13 may further identify additional risks for an at-risk patient group such as risk of comorbities. In an embodiment, the software instructions 13 may define an at-risk patient group based upon a plurality of identifiable risks. In another embodiment, the software instructions 13 may define a plurality of at-risk patient groups each based upon a single identifiable risk.

The server 10 may be further communicatively connected to a sensor data database 17 and a sensor network 18, the sensor network comprised of a plurality of workflow sensors 19. In an embodiment, the sensor data database 17 and sensor network 18 may be associated with one another such that data obtained from the workflow sensors 19 may be processed by a controller host within the sensor network 18, the data then stored upon the sensor data database 17. In an alternative embodiment, the workflow sensors may be processed by the server 10. In an embodiment, the sensor network 18 may be a mesh network or similar ad-hoc network.

The sensor network 18 may in an embodiment be a node network of workflow sensors 19, the workflow sensors 19 configured to detect clinical workflow data in association with at least one or more threshold values. For example, workflow sensors 19 may include non-interactive sensor devices such as motion detectors, temperature sensors, heart-rate monitors, urine monitors, patient health and usage monitoring systems (HUMS), and other such devices used to passively monitor a patient's condition. For further example, workflow sensors 19 may include interactive sensor devices such as therapy devices (e.g. sensor-enabled strength equipment, sensor-enabled endurance equipment, sensor-enabled flexibility equipment, etc.). In an embodiment, the workflow sensors 19 may be configured for remote deployment, the sensor network 18 itself configured as a telemedicine system for remotely sensing patient performance over time and with minimal invasiveness or inconvenience to the patient.

The workflow sensors 19 may be configured to monitor patient conditions in association with one or more clinical workflow stages. For example, a motion detector may monitor a patient's movement activity within a room to determine a degree of activity for the patient, the degree of activity stored upon the sensor data database 17. The degree of activity may be compared by the software instructions 13 to a threshold value stored upon the workflow information database 15 to determine whether the degree of activity exceeds one or more threshold values for degree of activity required for a clinical workflow step. For example, a patient at risk of complications from hip surgery may have an associated clinical workflow for physical therapy to reduce pain and increase mobility that requires movement around a room in increasing phases. For the first week, the patient may be prohibited from moving around the room for more than 15 minutes a day, whereas in the second week, the patient may be required to move around the room three times at least 15 minutes a day. A motion sensor may detect a patient's movement, the movement processed by the sensor network 18 and stored on the sensor data database 17 as movement data, the movement data then processed by the software instructions 13 to determine whether the patient is exceeding or otherwise complying with the relative minimums and maximums for each stage of the clinical workflow.

The system 10 may additionally be communicatively connected to an algorithm database 20 with workflow and patient risk algorithms stored thereupon. In an embodiment, workflow algorithms and patient algorithms may be stored separately or concurrently upon a plurality of algorithm databases 20. The software instructions 13 may determine at-risk patients and associated positive and negative outcomes based upon the patient risk algorithms and determine the one or more associated clinical workflows and relative priority thereof based upon the workflow algorithms. For example, a patient risk algorithm may define one at-risk patient group based upon a specific configuration of patient data 17, whereas another patient risk algorithm may define a second at-risk patient group based upon a second specific configuration of patient data 17. Likewise, workflow algorithms may each be associated with one or more clinical workflows. One or more workflow algorithms may further define a priority of workflow algorithms based upon maximization of positive outcomes and minimization of negative outcomes in accordance with mitigating factors for each outcome.

The system 10 may be communicatively connected to a user device 21 with a display unit. The user device 21 may be a computing device such as a personal computer, laptop, tablet, smartphone, and the like. The software instructions 13 may be configured to display or otherwise populate a graphical interface upon the display of the user device 21 comprising feedback data pertaining to one or more patients' performance in accordance with the various threshold values of one or more associated clinical workflows. The graphical display and feedback data thereof may display patients identified as at-risk, one or more associated positive and negative outcomes, one or more associated clinical workflows, and patient performance in adherence to threshold values for clinical workflow steps.

For example, a user may be able to view upon the display a patient identified as at risk for mortality, one or more determined odds of mortality at various lengths of time, clinical workflows for reducing risk or mortality and increasing odds of remission, various clinical workflow stages for a recommended clinical workflow, and patient performance and adherence to said workflow. In a further embodiment, a treatment workflow may include various clinical workflow steps including various, progressive steps of therapy. A user may be able to monitor patient progress and adherence to threshold values associated with each workflow step, such that following a specific treatment, the system displays results from patient data and sensor data including physical exams, medical scans, blood tests, and so forth, and whether those results are within parameters defined by the threshold values for continuance of that clinical workflow. If the results from one or more treatments do not yield sufficient results to raise patient performance within acceptable parameters or if mitigating factors relatively outweigh positive outcome benefits (e.g. the cost of treatment is too high or side-effects are too severe against the likelihood of successful treatment), then the software instructions 13 may flag the clinical workflow as problematic and display such workflow as problematic upon the user device 21's graphical display.

In an embodiment, the software instructions 13 may display on the user device one or more alternative clinical workflows based upon the determined workflow priority in accordance with one or more algorithms selected from the algorithm database 20. A clinical workflow involving a treatment step deemed problematic may warrant the system to suggest a different treatment clinical workflow without the same workflow step, where the different treatment clinical workflow has a higher determined priority when balancing positive/negative outcome variable weights and workflow mitigating factors. For example, the system may determine a clinical workflow using alternative therapies may ideally balance the positive outcome probability including mitigating factors such as risk of readmission, against negative outcome of mortality, including mitigating factors such as quality of life. Comparatively, the system may instead determine in some cases, such as where risk mortality and positive outcome mitigating factors are high and odds of readmission and negative outcome mitigating factors are low, that a clinical workflow involving discontinuance of hospital treatment is ideal. The system may then determine a hospice treatment workflow for improving quality of life for the patient.

In an embodiment, the graphical display of the user device 21 may be embodied as an interactive user interface wherein a user may select various data for display and accept or change a clinical workflow for a patient. In an embodiment, the user may be able to select a patient and assign a patient manually to an at-risk patient group, to select a clinical workflow from a list of prioritized clinical workflows, to select data associated with a clinical workflow or clinical workflow step, to select patient profile data such as patient health information and medical data, to change a currently assigned clinical workflow, and to modify the algorithms stored upon the algorithm database 20 or variable weights associated with said algorithms. In a further embodiment, the user may be able to assign or reassign one or more sensor networks 18 or one or more workflow sensors 19 to a patient. For example, the software instructions 13 may initially determine from the patient profile data 17 a patient's room and laboratory appointments and assign one or more sensor networks 18 for said room and laboratory appointments for that patient, and the user may reassign one or more workflow sensors 19 or sensor networks 18 not associated with the patient's room or laboratory appointments, such as when a workflow sensor 19 is assigned ad hoc and without appointment information or association to the patient via the patient information database 16.

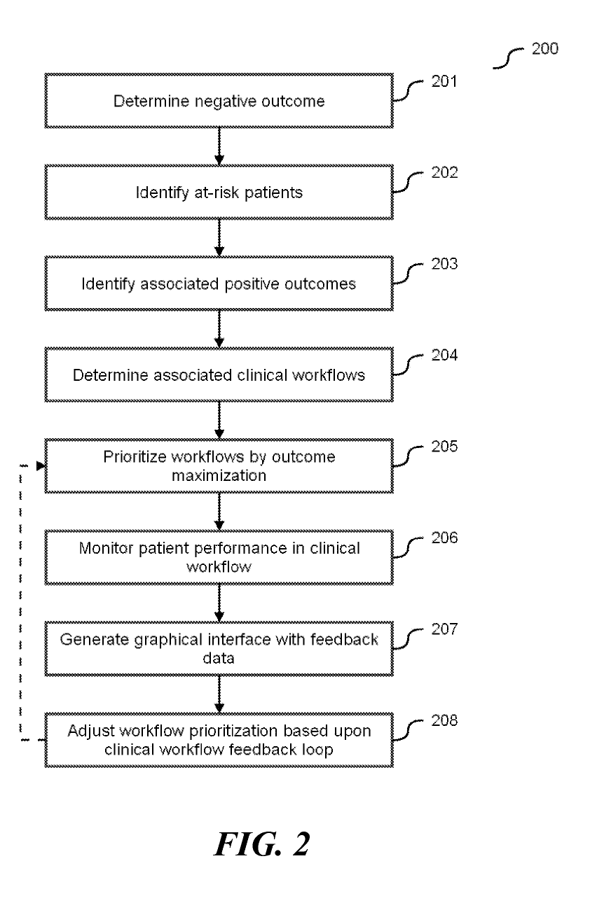

In a further embodiment, the user may be able to assign or reassign sensor networks 18 and workflow sensors 19 based upon commercial technologies such as wearable wellness technologies like heart-rate monitors, sleep monitors, blood pressure monitors, glucose monitors, and the like. Said commercial technologies may in certain embodiments include smartphone-based sensors configured to transmit sensor data to the server 10 and sensor data database 17, such as via a smartphone-enabled software application or application program interface (API).FIG. 2 is a flowchart representing an embodiment of a decision support method for clinical workflow optimization in accordance with the present disclosure. In an embodiment, FIG. 2 may be interpreted as an embodiment in reference to the embodiment described in FIG. 1. The decision support method 200 begins at a first step 201 wherein the decision support system identifies one or more negative outcomes for use in determining an at-risk patient group. The negative outcome may be determined in accordance with one or more algorithms selected from an algorithm database. In one embodiment, the determination of a negative outcome for identification of an at-risk patient group may be performed at the direction of a user. In another embodiment, the determination of a negative outcome for identification of an at-risk patient group may be performed periodically and continuously in accordance with software instruction parameters for ongoing risk assessment.

Upon determination of a negative outcome, the system then determines in step 202 one or more positive outcomes having an inverse correlation with respect to said negative outcome. Positive outcomes may be absolutely inverted to the negative outcomes so as to be mutually exclusive to one another. For example, a negative outcome of a patient's development of schizophrenia may have a directly inverse positive outcome of a patient's failure to develop schizophrenia. In some embodiments, positive outcomes may be partially inverted to the negative outcomes such that the positive and negative outcomes are not mutually exclusive or the corollary relationship between the outcomes is weak.

In some embodiments, the system may identify negative and positive outcomes concurrently. In one embodiment, the system may, for a given negative outcome, assign inverse positive outcomes as mitigating factors for the negative outcome and, for a given positive outcome, assign inverse negative outcomes as mitigating factors for the positive outcome. For example, a positive outcome of patient survival after 5 years may have a plurality of negative outcomes as mitigating factors including poor quality of life and high cost of treatment.

In step 203, the system determines patients from a patient database who have a relatively high risk of negative outcome and identifies said high-risk patients as an at-risk patient group. The determination of high risk patients may be made in accordance with patient profile data identified from or associated with one or more medical systems associated with the healthcare provider. For example, patient profile data may be determined partially or wholly from medical records databases such as EMR databases or HIS databases. In an embodiment, patient data may be initially determined from data obtained from the various medical records databases and stored as patient profile data upon the patient information database. In an alternative embodiment, patient data may be determined from the medical records databases as patient profile data and not stored upon a patient information database.

The system determines whether patients should be identified as an at-risk patient group based upon algorithms determined from an algorithm database. The algorithms may individually be created to identify patient profile data associated with a high risk of a negative outcome. For example, an algorithm for determining patients with a high risk of polycystic ovary syndrome may be programmed to determine patients' gender from the patient profile data and calculate risks only for female patients. Age may also be determined, such that in the previous example only women of reproductive age will be considered in the algorithmic determination.

A plurality of algorithms may be used to determine whether a given patient should be associated with one or more at-risk patient groups. In an embodiment, multiple algorithms may be used to determine an at-risk patient group defined by heightened risk for comorbidities. For example, patient data suggesting high dependence on alcohol and marijuana abuse may implicate algorithms associated with risk of alcoholism and substance abuse, the implication of both algorithms further implicating an associated algorithm for determining risk of depression. In alternative embodiments, a single algorithm may be used to determine associated symptoms and risks.

In some embodiments, the algorithms may be dynamically created, modified, and maintained by the system in accordance with a neural network engine and fuzzy logic association. The system may determine based upon ongoing analysis of patient data relationships between patient attributes, patient symptoms, and risk relationships, thereby creating associative algorithms. For example, where a system determines a correlating relationship between substance abuse and depression, the system may adjust analysis of a patient to identify a patient with a heightened risk of one negative outcome, e.g. substance abuse, as likely to have a heightened risk of another negative outcome, e.g. depression, by associating algorithms for each, as correlating or by creating an algorithm correlating to both negative outcomes and identifying heightened risks thereof if one does not exist.

In step 204, the system determines for an at-risk patient group one or more clinical workflows associated with the positive outcomes associated with the at-risk patient group. In an embodiment, the system may determine clinical workflows categorically, choosing, for example, at least one workflow based on treatment, at least one workflow based on quality of life, and at least one workflow based on cost minimization. In other embodiments, a plurality of clinical workflows may be determined without regard to categories. In certain embodiments, clinical workflows may be chosen based upon a plurality of at-risk patient groups where clinical workflows may address comparatively more risk categories.

In step 205, the system prioritizes the associated clinical workflows for sequential recommendation. In an embodiment, the system may determine a ranking of a plurality of clinical workflows from “best” to “worst” based upon comparative maximization of positive outcomes to negative outcomes. In other words, the system may determine which clinical workflows are comparatively more likely to achieve the highest number, quality, and/or quantity of positive outcomes while minimizing the likelihood of occurrence by number, quality, and/or quantity of negative outcomes. In some embodiments, the prioritization determination may be quantitative, such that the highest-ranked clinical workflow has the most number of positive outcomes associated and the least number of positive outcomes associated. In said embodiments, the rating determination may be expressed arithmetically by subtracting the number of negative outcomes of a certain risk from the number of positive outcomes of a certain risk.

In other embodiments, the prioritization determination may be qualitative based on degree or risk. For example, a clinical workflow associated with a high number of generally likely positive outcomes (e.g. marginally increased mobility, marginally increased quality of life) may be offset and de-prioritized based upon a significantly higher risk of a negative outcome (e.g. extremely high cost of clinical workflow procedure). In still further embodiments, the prioritization may account for diminishing returns in clinical workflow treatments and prioritize treatments less likely to result in repeated patient admissions or workflow steps.

Upon determination of a prioritized list of clinical workflows, the system may determine the highest priority workflow as a primary clinical workflow (step 206). In other embodiments, a user may select a primary clinical workflow from the list of prioritized workflows which may or may not be in accordance with the highest-ranked clinical workflow. For example, the system may require user selection of a clinical workflow if no highest priority clinical workflow is determined, e.g. in the case of a tie between clinical workflow rankings or if not enough data supports a prioritization determination. In some embodiments, the user may override the system's determination of a highest priority clinical workflow.

In step 207, the system may assign the highest priority clinical workflow to the at-risk patient group and then monitor the patients' condition throughout performance under the clinical workflow. In certain embodiments, the system may assign more than one clinical workflow to the at-risk patient group and monitor performance under each clinical workflow respectively. The system may monitor patient condition based upon clinical workflow sensor data and patient data collected on an ongoing basis. For example, in the case of a clinical workflow involving physical therapy, the system may monitor patient vitals and activities through clinical workflow sensors deployed with respect to the user and through test results entered into the patient information database.

In some embodiments, the system may associate user performance with a plurality of threshold values associated with one or more clinical workflow steps. In certain embodiments, threshold values may include a degree of activity of the patients and a degree of compliance with the clinical workflow. For example, a clinical workflow step may have a minimum threshold value for blood pressure (degree of compliance) and number of times a blood pressure may drop within a given time period (degree of activity). The system may determine whether the patient is in compliance with the clinical workflow step based upon the degree of activity; in the previous example, if the patient's blood pressure drops below the blood pressure threshold more than the number of times permitted by the activity threshold, then the patient may be deemed non-compliant with the workflow step.

In certain embodiments, each clinical workflow step may further have a threshold time value wherein the patient must attain compliance within the permitted time. For example, in a clinical workflow pertaining to removal from machine-implemented life support systems, a clinical workflow step may require a certain quantity of measurable brain activity within a time period, wherein the patient must meet a minimum threshold for brain activity within a specific period of time. In certain embodiments, threshold time values may be contiguous such that a threshold exists and is measured for meeting a certain number of time thresholds for a plurality of clinical workflow steps. In said certain embodiments, the system may determine compliance with each time threshold to further determine a rate of improvement and/or rate of diminishing return. For clinical workflows involving determination of hospice care, the system may monitor a time to compliance for repeated workflow steps; where time to compliance increases in subsequent repeated workflow steps beyond a rate-of-increase threshold or for a threshold duration, the system may determine irreversible decline and designate noncompliance with the clinical workflow.

In step 208, the system generates a graphical interface on a user device with feedback data, the feedback data including patient performance data when compared to the one or more threshold values. Feedback data may be transformative permutations of patient performance data in accordance with patient data algorithms to demonstrate statistical trends and compliance information. Performance data may be graphed over time and plotted against a threshold value to determine relative compliance with the clinical workflow or clinical workflow step and display said determination on the graphical interface. For example, a graph may demonstrate test performance over time, and another graph may demonstrate test performance over time normalized to a threshold value for test performance over time.

The graphical display of feedback data enables the user to determine whether a patient or provider is in compliance with clinical workflow steps and clinical workflow, allowing the user to make a determination of whether the clinical workflow is an effective treatment option for risk minimization. In an embodiment, the feedback data may be displayed via the graphical user interface for a single patient within the associated at-risk patient group. In other embodiments, the feedback data may be displayed for a plurality of patients within the at-risk patient group. In an embodiment, feedback data may be displayed for a plurality of at-risk patient groups and associated clinical workflows.

The graphical display may further visually indicate when a provider or patient group is noncompliant with the clinical workflow. In certain embodiments, the system may display alternative clinical workflows and compliance thereof, thereby allowing the user to quickly determine whether an alternative clinical workflow is a better clinical workflow to assign to said patient group. Said embodiments may be particularly helpful to users in determining whether to pursue which of two mutually exclusive clinical workflows. For nominative example, noncompliance with a terminal illness treatment clinical workflow may provide a user with statistical validation for determining to end treatment and begin a quality of life clinical workflow, such as hospice care.

In step 209, the system may adjust the clinical workflow selection and prioritization algorithms based upon a clinical workflow feedback loop. The system may perform continuous or periodic clinical workflow feedback analysis both for patient groups and for clinical workflow determination. For example, the system may monitor patient performance data and continually reprioritize clinical workflows based upon the optimization algorithms and process described in step 206 and upon the new patient performance data. The system may, therefore, change the prioritization of clinical workflows and recommended primary workflow based upon the continuous input of patient performance data and feedback data. In an embodiment, the system may recommend to a user via the graphic display generated in step 208 a new primary workflow where such reprioritization and selection of a new clinical workflow has occurred.

In certain embodiments, the system may adjust the algorithms and variables thereof in the algorithm database based upon continuous or periodic input of patient performance data and feedback data. In an embodiment, the system may create associative rules between algorithms based upon patient performance data. For example, the system may determine a previously unspecified positive or negative factor for a clinical workflow and associate said positive or negative factors in the clinical workflow determination algorithms; for a more specific example, the system may identify increased cardiovascular-related negative outcomes for patients associated with a clinical workflow involving testosterone treatment, whereupon the system may account for the cardiovascular-related negative outcomes in determination of the selection or prioritization of that clinical workflow where such association was not preprogrammed or otherwise represented in the algorithmic determination. In another embodiment, the system may adjust the prioritization algorithms based upon feedback data. For example, the system may de-prioritize clinical workflows that have a demonstrably higher rate of failure by adjusting the prioritization algorithm and relative weights or by adjusting the associated risk of negative outcomes and/or mitigating factors for the positive outcomes associated with the clinical workflow.

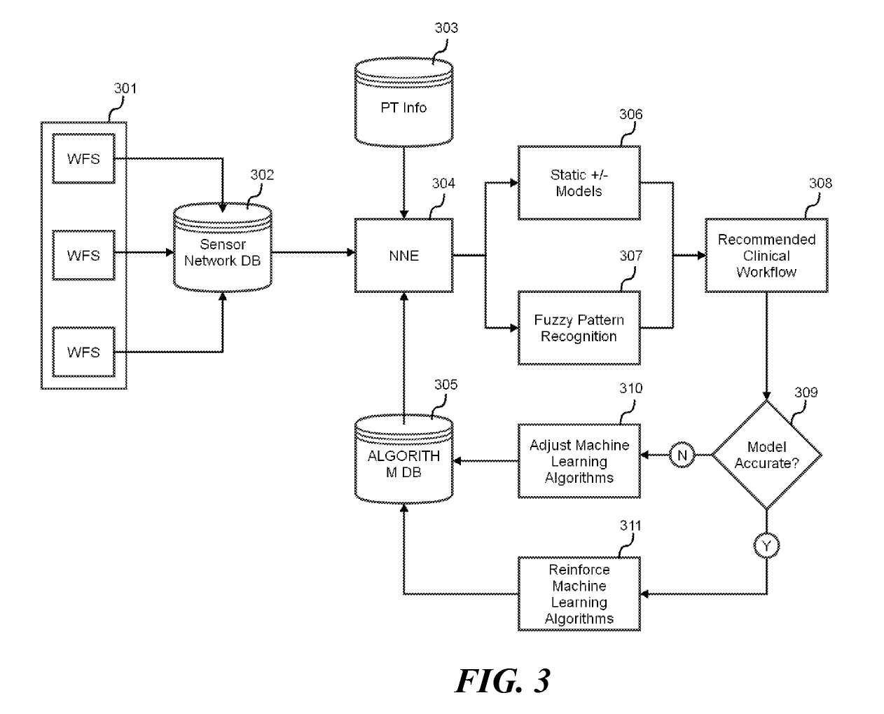

FIG. 3 is a block diagram representing an embodiment of a machine learning-based clinical workflow feedback loop in accordance with the present disclosure. The feedback loop receives patient performance data via one or more workflow sensors 301 deployed for detection of patient clinical workflow performance data. The workflow sensors 301 may in an embodiment be active and passive sensors for sensing patient health data such as, for example, heart rate, blood pressure, strength response, respiration, movement, blood content, and the like. The sensors may in an embodiment receive patient performance data subsequently stored upon a sensor network database 302. The patient performance data may be in certain embodiments transformed into feedback data via statistical modeling against various clinical workflow threshold values, wherein the patient performance data comprises data received by the workflow sensor and feedback data comprises qualitative and analytical data pertaining to whether said patient performance data indicates compliance with the clinical workflow or associated steps thereof.

In some embodiments, the workflow sensors 301 may track provider data as well as patient performance data. For example, an embodiment may track patient activity, patient status, and provider allocation of resources. The provider allocation of resources may be stored upon the sensor network database 302. In alternative embodiments, the provider allocation of resources may be determined from one or more hospital healthcare databases or a conjunction of hospital healthcare databases and workflow sensors 301. The provider data may be further transformed into feedback data for clinical workflow determination and threshold values thereof. For example, the allocation of provider resources may be determined to be in excess of one or more clinical workflow threshold values, such as, for example, when the administration of pain medication quantities exceeds a maximum, or. as an alternative example, when the number of hours of clinical care exceeds a maximum. In some embodiments, the feedback loop may also comprise a patient information database 303 with patient information stored thereupon. Patient information may include biomedical and healthcare-related information including, for example, name, height, weight, age, sex, medical diagnoses, medical history, imaging test results, and the like. Patient information may in some embodiments comprise information normally stored on HIS or EMR databases in relation to a patient.

Data from the sensor network database 302 and the patient information database 303 may be inputted into a neural network engine 304 for processing and eventual determination of one or more clinical workflow actions. The neural network engine 304 determines from the patient information database 303 and in some embodiments the sensor network database 302 a negative outcome for which one or more patients may be at risk. The neural network engine 304 may determine potential negative outcomes based upon algorithms stored within a connected algorithm database 305 and determine for one or more patients from the patient information database 303 a relative risk of a negative outcome in accordance with the algorithms of the algorithm database 305. Further in accordance with the algorithm database 305, the neural network engine 304 may determine one or more inversely correlated positive outcomes for the selected negative outcome. In some embodiments, the neural network engine 304 may compare a plurality of potential negative outcomes and associated positive outcomes simultaneously or iteratively.

The neural network engine 304 may determine one or more recommended workflow actions based upon statistical modeling. In an embodiment, multiple statistical modeling methods may be used. For example, in said embodiment, the neural network engine may process a recommended workflow action based upon a statistical comparison of predefined positive outcomes to predefined negative outcomes for each of plurality of clinical workflow actions (306) and determine therefrom one or more ideal models for maximizing a likelihood of positive outcomes and minimizing a likelihood of negative outcomes. For example, a clinical workflow model with comparatively high likelihood of positive outcomes and low likelihood of negative outcomes may be determined as more preferable than a second clinical workflow model with comparatively low likelihood of positive outcomes and high likelihood of negative outcomes. The neural network engine 305 may further weight the comparison of positive and negative outcomes based upon associated algorithms in the algorithm database 305, prioritizing the importance of certain positive or negative outcomes over comparative positive or negative outcomes.

The neural network engine 304 may further employ fuzzy logic algorithms to determine correlations between positive and negative outcomes between one or more clinical workflow models (307). For example, where definitive relationships between positive and negative outcomes do not exist, the neural network engine 304 may determine from historical and trend data correlations between certain positive or negative trends for one or more clinical workflow models and may weigh the relative importance of said positive and negative outcomes in determination of a recommended clinical workflow accordingly. For example, the neural network engine 304 may determine from historical patient information data and patient performance data a comparatively high likelihood of full recovery despite a relatively high cost and may weigh the likelihood of full recovery greater than the offsetting weight of the cost. In an embodiment, the system may weigh each positive and negative outcome variably in accordance with patient-specific or patient group-specific statistics. Continuing the previous example, an indigent patient without insurance may have a greater weight assigned to the negative outcome and mitigating factor of high cost than a wealthy patient, or alternatively a negative outcome of infertility may be weighed variably lower for a woman aged 79 than a woman aged 23.

The neural network engine 304 may determine from the outcome of algorithmic operations (306 and 307) at least one recommended clinical workflow for association with the determined at-risk patient group. In some embodiments, the neural network engine 304 may determine a plurality of recommended clinical workflows and prioritize said clinical workflows from most recommended to least recommended. The recommended clinical workflow may comprise a series of clinical workflow steps. In an embodiment, the recommended clinical workflow may be created by the neural network engine 304 by determining an ideal assembly of clinical workflow steps. In another embodiment, the recommended clinical workflow may be determined from one of a plurality of workflows stored within a clinical workflow database.

The neural network engine 304 then determines whether the recommended clinical workflow 308 is the ideal workflow for the determined at-risk patient group by continuously monitoring patient performance data from the workflow sensors 301, determining feedback data therefrom, determining whether an at-risk patient group is in compliance with the recommended clinical workflow, and identifying whether a previously un-recommended clinical workflow becomes an ideal workflow for the at-risk patient group. Where an at-risk patient group's patients become repeatedly noncompliant with the first recommended workflow and a second, previously un-recommended workflow is determined to be a better recommendation based upon patients' compliance with the second workflow, the system may determine for future at-risk patient group analyses for a particular negative outcome that the second workflow should be recommended over the first. In certain embodiments, clinical workflow steps may be added to or subtracted from the first recommended workflow, thereby transforming the first recommended workflow into a second recommended workflow. In other embodiments, the neural network engine 304 may determine a new workflow based upon association of previously disassociated negative outcomes.

For example, the neural network engine 304 may determine for a patient group at risk of complications from toxoplasmosis that an associated risk of a negative outcome of brain edema is likely to occur, the determination having been made from a combination of, or individually, patient performance data determined from the workflow sensors 301 and patient information on the patient information database 303. The neural network engine 304 may determine therefrom that a clinical workflow for toxoplasmosis treatment should include one or more clinical workflow steps for brain edema treatment like oxygen therapy or medication for reducing swelling and may either add one or more of said steps to the initially determined workflow or select another workflow with said workflow steps already included. Alternatively, the neural network engine may 304 determine an association between negative outcomes for toxoplasmosis and brain edema and may adjust its risk determination algorithms accordingly.

If based upon the patient performance data and patient information data received over time and during the course of the recommended clinical workflow the system determines that the recommended clinical workflow 308 is not the ideal clinical workflow for an at-risk patient group or one or more associated negative outcomes, then the neural network engine 304 may adjust the machine learning algorithms 310 used to determine one or more of: the at-risk patient group, the association of positive and negative outcomes, and the determination of a recommended clinical workflow. The algorithmic adjustment may result in the creation of new algorithms, the modification of existing algorithms, or the change in weight of algorithmic variables thereof. For example, a clinical workflow model deemed less efficacious may be devalued by adjusting one or more variables of the associated algorithm or algorithms, said variables contributing to importance of the clinical workflow model in prioritization against other models, downward. Likewise, a model deemed more important may be promoted by increasing variable weights. The adjustment of the machine learning algorithms 310 may be stored in the algorithm database 305 such that future iterations of the neural network engine 304 process may more accurately determine an ideal clinical workflow for a negative outcome and new associated at-risk patient group as the recommended clinical workflow 308.

If based upon the patient performance data and patient information data received over time the system determines that the recommended clinical workflow 308 is the ideal model for recommendation, then the system may reinforce the machine learning algorithms 311 stored in the algorithm database 305. In an embodiment, the system may reinforce the algorithms by adjusting the algorithms or variables thereof to increase the certainty of the determination. In the case of a fuzzy logic algorithm, the system may increase the probabilistic weight to the algorithmic outcomes to increase the probabilistic outcome of the same result closer to “1.” In an alternative embodiment, the system may reinforce the machine learning algorithms by not performing any modification to the algorithms or variables thereof.

Referring next to FIG. 4, an example embodiment of a process 400 may be described for determining an at-risk group of patients with respect to a negative outcome associated with a healthcare provider. Generally, the system may generate and convey negative outcome risk scores and quotients for each patient in a census of patients associated with the particular healthcare entity, wherein a sub-group of the overall census may be considered at-risk based on various selection or filtering criteria.

In step 402, the system collects, extracts, receives or otherwise obtains patient data from the healthcare entity or an agent thereof via a communications network. An associated data collection module may introduce patient data to the host system as provided from, e.g., a home healthcare agency. In a particular embodiment the data is acquired from a third party data source associated with the agency and which is used to electronically store OASIS-C patient data or an equivalent, but alternatively the patient data may be acquired from the agency directly. The patient data may be extracted in the form of for example comma-separated value (CSV) text files with time stamps. The data may include but is by no means limited to personal and historical data regarding basic demographics, medications, healthcare providers (doctors, specialists, etc.), and contact information. Data collection may be implemented via for example an export/import software package such as Symantec Security Information Manager (SSIM) event collector interface with associated ETL (extract, transform, load) tools. The data collection process in various embodiments may be conducted automatically at predetermined time intervals with respect to the healthcare entity, wherein data for a plurality of associated patients may be collected at the same time, or at intervals which are determined in accordance with particular patients, wherein certain patients may require more frequent data collection and screening than others. The data collection intervals may further be adjustable with regards to changes in agency rules, medication data or new patient information.

From the obtained set of patient data, the system may then (in step 404) separately extract current medication data and OASIS-C data for the patient. The OASIS-C data is independently normalized and populated into a hosted neural network database (in step 406). The neural network database may in various embodiments be a hosted database which is created specifically for use within a neural network sub-system, or may be any hosted database which comprises a data structure compatible with the language used by a neural network engine as implemented by the hosted system.

The current medication data for the patient may alternatively be submitted into a medication risk assessment engine (step 408) wherein risk weights are assigned for each individual medication associated with the current medication data and an aggregate medication risk score for the patient is generated from the various individual risk scores (step 410). For example, if the patient data includes a medication profile with three current medications, one which has been assigned a predetermined risk weight of two (e.g., Cordarone), one which has been assigned a predetermined risk weight of three (e.g., Cimetidine) and another which has been assigned a predetermined risk weight of four (e.g., Librium), the aggregate medication risk score for the patient would be (2+3+4)=9. This generated medication risk score is then populated into the neural network database in association with the normalized OASIS-C data (step 412).

In an embodiment, a medication risk assessment module may compare patient data, or more particularly a current medication profile associated with a patient as included in the patient data, with predetermined risk weights which may each be further rated in accordance with one or more risk priority levels (thresholds). The medication risk assessment module may typically assign risk weights to each current medication based on a comparison to predetermined medication data stored in a database or the like and having corresponding medication criteria. In certain embodiments, a medication having a risk weight greater than a threshold risk level may be designated as being “high-risk” and the medication risk module may further automatically prepare and transmit corresponding alerts.

The predetermined criteria may in various embodiments be defined by the particular healthcare provider, and may be defined ad-hoc or otherwise may include or merely consist of a publicly available or otherwise well-known set of predetermined criteria as may be incorporated from a third party database or the like. Examples of criteria to be applied may include without limitation particular medications or categories of medications, dosages, delivery mechanisms, contra-indications associated with other current medications being taken by the patient, duplicative medications, potential adverse reactions, etc.

Threshold priority levels may further be predetermined as defined by the agency, derived from related factors according to the predetermined criteria, or others within the scope of the invention.

In an exemplary application of a medication risk assessment module, an administrator or other approved user may assign risk weights to individual medications which may then be stored in a database for subsequent extraction. A risk weight of one (1) may be assigned to relatively low-risk medications, such as for example ferrous sulfate. A risk weight of two (2) may be assigned to medications having slightly greater, but still relatively low, risks associated with them, such as for example Amiodarone. In like manner, risk weights of increasing grade may be assigned to medications associated with corresponding degrees of risk, such as for example a risk weight of three (3) may be assigned to Cimetidine, a risk weight of four (4) may be assigned to Chlordiazepoxide, and a risk weight of five (5) may be assigned to Carisprodol. It may be understood that those of skill in the art may independently develop and assign different degrees of risk and corresponding risk weights for the same medications and criteria (e.g., dosage, delivery).

In an embodiment, the medication risk assessment process may be capable of recommending adjustments to risk priority levels based on a patient profile. The patient data such as the typically provided OASIS-C data components may define a patient health profile in addition to or otherwise comprising the current medication profile. The health profile may be used to identify nominal priority levels for each associated medication. The system may be further effective upon receiving the patient data or modifications to the patient data to generate or modify a patient health profile based thereon, and which may be derived from the current medications, historical medication data, healthcare provider input, monitored patient activity, and/or the like. The system may then identify a nominal priority level for one or more of the predetermined criteria based on the generated patient health profile, which nominal levels may for example be predetermined with respect to various stages of a conventional health profile derived by or otherwise stored within the host system, or may be for example obtained from a third party source. In other words, the system may identify a stage or status associated with the patient, and associate the identified health status with a nominal priority level for risk purposes. The priority level provided by the agency for the one or more criteria may then be compared to the respective identified nominal priority level, at which point the system may automatically or periodically generate recommendation reports to the agency including the identified nominal levels or otherwise suggesting potential modifications of the provided priority levels.

The OASIS-C data variables and the generated medication risk scores associated with the patient may then be entered into or otherwise extracted for implementation by the negative outcome risk assessment engine (step 414), and a negative outcome risk score generated for the patient (step 416).

A negative outcome risk assessment module may for example generate a relative risk score for the various patients, based on in one example the patient profile including the current medication profile and the risk weights (or aggregate score based on a plurality of risk weights) generated via the medication risk assessment module, and stores the relative risk score in a hosted database in association with the patient data. Monitored patient activity or conditions based on data received from a sensor network may further be implemented by the risk assessment module. In various embodiments, the risk assessment module may further utilize parameters such as historical data, primary healthcare provider input, etc.

In a particular embodiment, risk scores for a plurality of patients may be generated in accordance with the following exemplary process. First, a data file is accessed, or otherwise generated or extracted for example from the hosted database for the purpose of a risk screening iteration, which may contain relevant patient data for each patient associated with a particular healthcare entity. The data file may be in the form of a spreadsheet having rows for each patient and columns for each of a plurality of parameters including for example and without limitation sex, marital status, diseases as described with respect to for example levels or stages, symptoms, recent events such as falls or surgical procedures, drug regimen including risk levels associated therewith, recent or timely providing of care including for example interventions, and other parameters as may be understood to be relevant by those of skill in the art.

Each parameter may be associated with a static defined value (such as for example “1” for males under the “sex” parameter and “2” for females, or a predetermined value representing a degree or type of intervention) or may be a variable that has been previously scored or determined by the system based on the input data in the database (such as for example a predetermined value assigned to the parameter based on specific findings in the health profile or the medication profile, such as criteria measuring the effectiveness of interventions by comparing the progress or lack thereof for the patient with respect to previous rankings and intervention scores).

In an embodiment, one or more determined variables associated with the patient profile may be further tested for their reliability by executing a variable cross-checking or variable strengthening algorithm. As represented in FIG. 6, and by reference to an example wherein the negative outcome is defined as acute care or hospitalization transfer, an exemplary such algorithm 600 may include identifying a primary variable 602 as the subject of the cross-checking routine, and further identifying one or more correlated variables 604a, 604b, 604c, across other data sources or locally stored input for cross-checking against the primary variable 602. Generally speaking, the correlated variables 604 may include variables that have previously been identified or determined as displaying exceptional discrimination with respect to the primary variable 602, such identification having been made manually or automatically across an array of patients or even with respect to that particular patient over time. The process continues by calculating a variable alignment score 606, which may further be determined as representing a high level of support 608a or a low level of support 608b with respect to predetermined support thresholds or as further determined in view of historical trends or relevance.

A first exemplary variable cross-checking process may be conducted with respect to a Previous Hospitalization Risk variable, as cross validated with for example a confirmed history of transfer for a patient.

Another example may refer to an Ambulation variable, as cross validated with other functional attributes such as, e.g., Bathing, Grooming, Dress, etc. The conceptual basis here may be an expectation that a bed-bound patient is unable or substantially less able to bathe themselves independently.

Yet another example may be cross validating one or more Clinical Diagnoses (e.g., ICD9 codes) with Medications to generate or improve upon other variables relating to a patient's conditions or health status. For example, a patient taking insulin may be associated with diabetes although he/she has other diagnoses which make no such mention.

The process may subsequently identify hospitalization risk criteria for the particular patients (e.g., predetermined criteria for each patient or identified individually for the patients based on their profiles) and further generate a hospitalization risk score based on the parameters (i.e., variables and/or set values) associated with the various criteria and populating the data file. In one example, certain of the parameters may be assigned to one of a plurality of blocks of parameters (as may for example distinguish permanent or semi-permanent status parameters such as age and sex from temporary conditions or current treatment regimen), the parameters in a given block being collectively weighted as a proportion of an aggregate score. Certain of the values may be compared with a nominal value associated with the particular criteria, and weighted in accordance with their different from the nominal value, or otherwise weighted in accordance with their importance as determined with respect to a combination of other factors. For example, the system may define a block of parameters for a patient with a particular medical condition in combination with their age and current frequency of treatment, and may weight this customized block according to predetermined steps set in an algorithm that has been programmed to recognize such a combination and act accordingly. The system may further as alluded to above weight parameters such as for example intervention status based in part on the progress or lack thereof with respect to previous rankings.

In an embodiment, the risk assessment module may utilize an above-referenced block or otherwise undefined plurality of several independent but related variables in combination to generate a continuous numerical variable. In an embodiment of a continuous variable manufacturing process, one or more of the independent but related variables may be obtained as output from a cross-checking process as described above. The variables are then aggregated and subjected to a ranking function wherein the continuous variable is generated including each of the underlying values/variables but more broadly representative of a particular status or condition at issue. The new continuous variable typically may have predetermined lower bounds and upper bounds, with lower values and upper values representing lower risk and higher risk, respectively. The continuous variable may then be used independently to identify a particular patient status or condition, and/or as one of a plurality of input variables in a risk assessment scoring algorithm.

A first exemplary continuous variable may be a Patient Mobility Level, wherein the host system constructs a variable representing the patient's ability to perform a given function. Such a variable may be generated according to a weighted plurality of defined sub-values or variables such as, e.g., general ambulation, grooming, bathing, transferring and other relevant attributes.

Another example may be an Overall Patient Status which considers a severity of diagnosis, caregiver involvement, environmental variables, and a patient's overall status as manually entered, for example by a nurse or the equivalent.

Yet another example may be a Patient Cognitive State, which may be used for example to indicate mild to moderate dementia by leveraging cognitive, anxiety and memory variables from Oasis alongside types of medications and medication history.

The process may further generate hospitalization risk scores in conjunction with a relative risk for each individual medication. For example, an aggregate score of eleven (11) for the sum of the individual medication risk weights for a particular patient, wherein none of the individual risk weights is over a threshold risk priority level for that particular patient, based for example on his or her health profile, may be scored differently by the hospitalization risk module 18c than an aggregate score of eleven (11) for another patient wherein one or more individual medications are above an associated risk threshold. Alternatively, the trigger may be a total number of medications above a particular threshold level, wherein one patient with an aggregate risk score of ten (10) but with two medications having risk weights of five (5) each may be deemed riskier than a second patient with an aggregate score of twelve (12) but with no medications having individual risk weights over two (2).

The system may be programmed to automatically rank the hospitalization risk score for each patient as it is generated with respect to risk scores for other patients who are associated with the same healthcare entity, and to generate an electronic document in the form of for example a risk report for the provider including any one or more of the individual, ranked and/or aggregated risk scores for the patients associated with the provider. Accordingly any recipient may be able to efficiently determine where to best allocate scarce resources based not only on the degree of need or risk for any one patient, but on a relative need or risk for each patient relative to each other patient in an associated census for that healthcare entity.

The risk assessment module may be programmed to perform a scoring iteration on predetermined time intervals, such as for example nightly, in order for example to determine scoring adjustments as may result from for example changes to a patient's regimen, interventions, etc.

Algorithms and processes of the risk assessment module may be programmed in a first iteration associated with a patient to generate a risk assessment score based on a first plurality of variables, and subsequently to generate risk assessment scores taking into consideration the previous scores or rankings thereof. In many cases, a patient's previous ranking is a strong predictor when used in a future episode or iteration for the same patient.

In an embodiment, a historical ranking process may identify the result of a previous iteration of the risk assessment scoring algorithm and compare the previous result to a current actual output from the risk assessment scoring algorithm. A new variable may then be derived based on a difference between the previous and the current scores, and in certain embodiments the severity and the direction of any such difference.

The historical ranking process may even further account for distinctions between or among the underlying and internal variables themselves. For example, in this particular portion of a risk assessment scoring process, historical distinctions with respect to one or more underlying variables may be deemed less critical than others, particularly with respect to a particular patient condition, age, etc. In other words, a given value for a difference in the risk assessment score with a first combination of underlying variables may not be as strong of a predictor for future episodes of the same patient as the same overall value but with a second combination of underlying variables. This may be the case where in a first example each of the variables are on the high end of a “safe” range but none exceed any high-risk thresholds, but in a second example most of the variables are lower-risk but one variable in particular is very high-risk.

In an embodiment, the system may be programmed to continuously or periodically monitor and thereby automatically identify trends and correlations in negative outcome risk with respect to the aggregated risk scores. Accordingly, systems and methods of the present invention may be effective to modify the predetermined rules for generating the risk score, such as wherein for example a correlation between a particular variable and a high risk score may be found to have weakened over time with respect to what was originally thought. Rather than be based wholly or in part on monitoring by the system and/or processing of input data with respect to the aggregated scores, the system may further or alternatively modify the predetermined rules in accordance with third party input, particularly where input from such third party had been a basis for the initial or previous set of rules.

The above process steps 402 through 416 may typically be performed in at least one iteration with respect to each patient associated with the healthcare entity or at least for each patient for which negative outcome risk assessment is to be provided. At predetermined intervals, or at any given time such as where a risk report has been requested for the entire census of patients, the method may further rank the risk scores for each associated patient (step 418) and generate a risk report for the client (step 420). Typically, the risk report may rank the patients most in need of care or otherwise corresponding with the highest risk of the negative outcome (e.g., acute care transfer) based on their risk scores, but a user interface as disclosed herein may include client preference data entry fields wherein the client may configure a report layout or otherwise customize the presentation.

In an embodiment, a system and method as disclosed herein may further process patient data in accordance with a mortality predictive model to estimate each patient's likelihood of expiration within an approaching time window. In a particular example, such a predictive model could be used to identify patient candidates for an earlier admission to hospice.

The data may preferably be input from the OASIS-C assessment and medication utilization as described above. A re-sampling technique (bootstrapping) may be applied to test for the robustness of estimates. Bootstrapping has the further advantage of avoiding distributional assumptions. In one particular example, the model was applied and identified a set of twelve significant risk factors for patient expiration within ninety days. One of the greatest risk factors was determined to be cancer risk (patients with cancer risk are almost three times more likely to expire than those without), but ulcer risk level was also notable. Other significant risk factors included Dypsnea Oxygen Risk, Current Dress Upper and Grooming Risk, Ambulation and Transfer Risk, Cognitive Risk, Feeding Risk, Bowel Incontinence Risk, and Need of Physical Therapy. The likelihood of ninety-day expiration was thus determined to be an increasing function of all the risks identified. Age was also a significant risk factor: ceteris paribus, the older the patient, the more likely to expire.

In various embodiments, the mortality predictive model may be implemented alongside negative outcome or positive outcome predictive models to determine a group of patients within a census of patients who may be suited for hospice transfer. Clinical workflows may for example be geared by the system to drive resource allocation by the healthcare provider with respect to a more positive end of life experience, for the respective patient groups that are capable of receiving the same.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A system for providing decision support regarding clinical workflows for a healthcare provider having a census of patients, the system comprising:
a processor functionally linked to a data repository comprising profile data for each of the census of patients;
a sensor network configured to deliver real-time patient condition data for each of the census of patients to the data repository;
a non-transitory computer readable medium further comprising program instructions executable by the processor to direct operations of
processing at least the profile data and the condition data to determine a relative risk value for each of the census of patients with respect to a negative outcome associated with services of the healthcare provider;
defining a group of patients from among the census of patients as being at-risk with respect to the determined negative outcome;
determining a positive outcome having an inverse correlation with respect to said negative outcome;
defining a clinical workflow as a sequence of one or more treatment stages associated with the determined positive outcome;
tracking a degree of activity by the healthcare provider for the defined group of at-risk patients and with respect to at least a first threshold value, and further tracking a degree of compliance by the healthcare provider with the clinical workflow based on at least a second threshold value; and
generating a graphical interface on a display unit for a user device comprising feedback data regarding a failure to satisfy either of the first threshold value and the second threshold value.

2. The system of claim 1, wherein tracking a degree of activity by the healthcare provider comprises tracking and processing data stored by the healthcare provider in the data repository to determine relative resource allocation by the healthcare provider with respect to at least a first threshold value, the at least first threshold value corresponding to relative treatment values for each of the defined group of at-risk patients.

3. The system of claim 2, wherein the at least first threshold value comprises a plurality of threshold treatment values determined for the healthcare provider with respect to respective ones of the defined group of at-risk patients, the program instructions further executable to direct an operation of dynamically adjusting threshold treatment values based on real-time aggregation and processing of patient condition data and patient profile data.

4. The system of claim 1, wherein tracking a degree of compliance comprises tracking an amount of time for each patient with respect to the clinical workflow.

5. The system of claim 4, wherein the second threshold value comprises one or more threshold time values respectively corresponding to each of the one or more stages of the clinical workflow,
further wherein tracking a degree of compliance comprises tracking an amount of time for each patient with respect to each of the one or more stages of the clinical workflow and with respect to the corresponding threshold time values.

6. The system of claim 5, wherein the program instructions are further executable to direct operations of, for each of the one or more stages of the clinical workflow and for a given patient,
predictively assessing a relational effect of compliance or non-compliance with the respective threshold time value upon any one or more subsequent stages in the clinical workflow,
tracking actual compliance by the healthcare provider and the patient with respect to the respective threshold time value, and
dynamically adjusting threshold time values for one or more the subsequent stages in the clinical workflow.

7. The system of claim 5, wherein the program instructions are further executable to direct operations of, for each of the one or more stages of the clinical workflow and for a given patient,
predictively assessing a relational effect of compliance or non-compliance with the respective threshold time value upon the determined positive outcome,
tracking actual compliance by the healthcare provider and the patient with respect to the respective threshold time value, and
dynamically adjusting threshold time values for one or more the subsequent stages in the clinical workflow.

8. The system of claim 5, wherein the program instructions are further executable to direct operations of, for each of the one or more stages of the clinical workflow and for a given patient,
predictively assessing a relational effect of compliance or non-compliance with the respective threshold time value upon the determined negative outcome,
tracking actual compliance by the healthcare provider and the patient with respect to the respective threshold time value, and
dynamically adjusting threshold time values for one or more subsequent stages in the clinical workflow.

9. The system of claim 4, wherein tracking a degree of compliance further comprises tracking a number of instances of any of the one or more patients being removed from the workflow.

10. The system of claim 4, wherein tracking a degree of compliance further comprises tracking a number of instances of any of the one or more stages being removed from the workflow.

11. The system of claim 1, wherein the program instructions are further executable to direct the performance of an operation of:
determining, for each of the patients in the census of patients, a likelihood of expiration within a date range,
wherein the negative outcome comprises transfer to an acute care facility, and the positive outcome comprises admission to hospice care without transfer.

12. A method for providing decision support regarding clinical workflows for a healthcare provider having a census of patients, the method comprising:
processing at least real-time condition data and profile data for each of the census of patients to determine a relative risk value for each of the census of patients with respect to a negative outcome associated with services of the healthcare provider;
defining a group of patients from among the census of patients as being at-risk with respect to the determined negative outcome;
defining a clinical workflow as a sequence of one or more treatment stages associated with a positive outcome having an inverse correlation with respect to said negative outcome;
tracking a degree of activity by the healthcare provider for the defined group of at-risk patients and with respect to at least a first threshold value;
tracking a degree of compliance by the healthcare provider with the clinical workflow based on at least a second threshold value; and
generating a graphical interface on a display unit for a user device comprising feedback data regarding a failure to satisfy either of the first threshold value and the second threshold value with respect to any one or more of the census of patients.

13. The method of claim 12, wherein tracking a degree of activity by the healthcare provider comprises determining relative resource allocation by the healthcare provider with respect to at least a first threshold value, the at least first threshold value corresponding to relative treatment values for each of the defined group of at-risk patients.

14. The method of claim 13, wherein the at least first threshold value comprises a plurality of threshold treatment values determined for the healthcare provider with respect to respective ones of the defined group of at-risk patients, the method further comprising:
dynamically adjusting threshold treatment values based on real-time aggregation and processing of patient condition data and patient profile data.

15. The method of claim 12, wherein tracking a degree of compliance comprises tracking one or more threshold values respectively corresponding to each of the one or more stages of the clinical workflow, the method further comprising:
for each of the one or more stages of the clinical workflow and for a given patient,
predictively assessing a relational effect of compliance or non-compliance with the respective threshold value upon any one or more subsequent stages in the clinical workflow,
tracking actual compliance by the healthcare provider and the patient with respect to the respective threshold value, and
dynamically adjusting threshold values for one or more the subsequent stages in the clinical workflow.

16. The method of claim 12, wherein tracking a degree of compliance comprises tracking one or more threshold values respectively corresponding to each of the one or more stages of the clinical workflow, the method further comprising:
for each of the one or more stages of the clinical workflow and for a given patient,
predictively assessing a relational effect of compliance or non-compliance with the respective threshold value upon the positive outcome,
tracking actual compliance by the healthcare provider and the patient with respect to the respective threshold value, and
dynamically adjusting threshold values for one or more the subsequent stages in the clinical workflow.

17. The method of claim 12, wherein tracking a degree of compliance comprises tracking one or more threshold values respectively corresponding to each of the one or more stages of the clinical workflow, the method further comprising:
for each of the one or more stages of the clinical workflow and for a given patient,
predictively assessing a relational effect of compliance or non-compliance with the respective threshold value upon the negative outcome,
tracking actual compliance by the healthcare provider and the patient with respect to the respective threshold value, and
dynamically adjusting threshold values for one or more the subsequent stages in the clinical workflow.

18. The method of claim 12, wherein tracking a degree of compliance further comprises:
tracking a number of instances of any of the one or more patients being removed from the workflow, and
tracking a number of instances of any of the one or more stages being removed from the workflow.

19. The method of claim 12, further comprising:
determining, for each of the patients in the census of patients, a likelihood of expiration within a date range,
wherein the negative outcome comprises transfer to an acute care facility, and the positive outcome comprises admission to hospice care without transfer.

20. A system for providing decision support regarding clinical workflows for a healthcare provider having a census of patients, the system comprising:
a data repository comprising profile data for each of the census of patients;
a sensor network configured to deliver real-time patient condition data for each of the census of patients to the data repository;
means for defining a group of patients from among the census of patients as being at-risk with respect to a negative outcome associated with services of the healthcare provider;
means for tracking activity by the healthcare provider for the defined group of at-risk patients and with respect to at least a first threshold value;
means for defining a clinical workflow as a sequence of one or more treatment stages associated with a positive outcome having an inverse correlation with respect to said negative outcome;
means for tracking compliance by the healthcare provider with threshold values corresponding to the one or more stages of the clinical workflow;
means for dynamically adjusting the threshold values corresponding to the one or more stages of the clinical workflow; and
means for generating a graphical interface on a display unit for a user device comprising feedback data regarding a failure to satisfy any one or more of the first threshold and the threshold values corresponding to the one or more stages of the clinical workflow.
